(19) United States
(12) Patent Application Publication
(10) Pub. No.: US 2017/0163761 A1
(43) Pub. Date: Jun. 8, 2017

(54) METHOD, DEVICE AND SYSTEM FOR OBTAINING LIVE VIDEO

(71) Applicants: Le Holdings (Beijing) Co., Ltd., Beijing (CN); LeCloud Computing Co., Ltd., Beijing (CN)

(72) Inventors: Fengyu Liu, Beijing (CN); Chao Li, Beijing (CN); Yangang Xia, Beijing (CN)

(21) Appl. No.: 15/246,514

(22) Filed: Aug. 24, 2016

Related U.S. Application Data
(63) Continuation of application No. PCT/CN2016/088919, filed on Jul. 6, 2016.

(30) Foreign Application Priority Data
Dec. 7, 2015 (CN) 201510890847.6

(51) Int. Cl. H04L 29/08; H04L 29/06

(52) U.S. Cl. CPC H04L 67/32; H04L 65/4069

(57) ABSTRACT

Disclosed are a method, a device and a system for obtaining live video. The method for obtaining live video includes: receiving an uploading request for uploading live video from a host user; selecting a resource server for processing the uploading request among multiple distributed resource servers; and sending the uploading request to the resource server so that the resource server receives the live video uploaded by the host user.

### CROSS REFERENCE TO RELATED APPLICATIONS

This application is a continuation of International Application No. PCT/CN2016/088919, filed on Jul. 6, 2016, which is based upon and claims priority to Chinese Patent Application No. 201510890847.6, filed on Dec. 7, 2015, the entire contents of which are incorporated herein by reference.

### TECHNICAL FIELD

The present disclosure relates to computer technologies, and more particularly, to a method, a device and a system for obtaining live video.

### BACKGROUND

Online live broadcasts, which are based on the Internet platform, offer people with more operational initiatives as compared with conventional live broadcasts. In other words, people can have better options and can choose more freely. For example, current popular live broadcasts of sport events like ball games, wedding, opening of new business and the like, bring great convenience to users. For example, signals about these broadcasts are posted on the Internet, users can conveniently select live broadcast paths as desired by them, and then they can view the online video at any place where networks are available.

Online live broadcasts are generally implemented as follows. A user produces streaming media data for live video broadcasting, and then uploads the streaming media data to a resource server for storing data in a live broadcasting platform via networks. When other users request to view the live video, the resource server in the live broadcasting platform can send the streaming media data of the live video to the users who want to view the video. For most live broadcasting platforms at present, resource servers is deployed at a position in a centralized way so as to reduce operation and maintenance costs. However, with the developments of Internet, users have been paying increasingly more attention on speed and effect of browsing of websites, and explosion in user number and over long network access paths will seriously influence access quality of users. Particularly, for the online live broadcasts featured by realtime performance and large capacity, users' view quality cannot be guaranteed.

### SUMMARY

The present disclosure provides a method, a device and a system for obtaining live video so as to solve the problem of overheavy load resulted from large number of user accesses to live video by deploying distributed resource servers.

In order to realize the above objective, the present disclosure generally provides the following technical solutions.

In a first aspect, embodiments of the present disclosure provide a method for obtaining live video, implemented by a scheduling server, including:

receiving an uploading request for uploading live video from a host user;

selecting a resource server for processing the uploading request among multiple distributed resource servers; and

sending the uploading request to the resource server so that the resource server receives the live video uploaded by the host user.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for obtaining live video mentioned by embodiments of the present disclosure.

In a third aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to:

receive an uploading request for uploading live video by a host user from a scheduling server;

receive, according to the uploading request, the live video uploaded by the host user; and

using a content delivery network, send the live video to a client on which a viewer requests to view the live video.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for obtaining live video in accordance with some embodiments.

FIG. 2 is a flow chart of another method for obtaining live video in accordance with some embodiments.

FIG. 3 is a flow chart of another method for obtaining live video in accordance with some embodiments.

FIG. 4 is a block diagram showing a structure of a device for obtaining live video in accordance with some embodiments.

FIG. 5 is a block diagram showing a structure of another device for obtaining live video in accordance with some embodiments.

FIG. 6 is a block diagram showing a structure of another device for obtaining live video in accordance with some embodiments.

FIG. 7 is a block diagram showing a structure of another device for obtaining live video in accordance with some embodiments.

FIG. 8 is a block diagram showing a system for obtaining live video in accordance with some embodiments.

FIG. 9 is a block diagram showing a device for obtaining live video in accordance with some embodiments.

FIG. 10 is a block diagram showing a structure of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

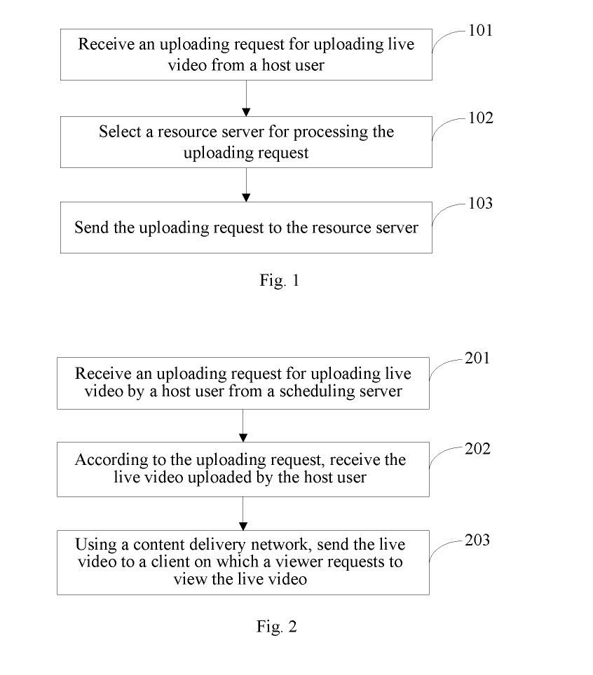

An embodiment of the present disclosure provides a method for obtaining live video. As shown in FIG. 1, the method is applied in a scheduling server in a video platform. The scheduling server is used for receiving video uploading requests from all users in the video platform and meanwhile has the function of a Domain Name System (DNS) server. The method can include the following specific steps.

In 101, a scheduling server receives an uploading request for uploading live video from a host user.

Before uploading live video, the host user needs to send an uploading request to the video platform, and after getting permission from the video platform, the host user can upload video to a resource server in the video platform. In an embodiment of the present disclosure, it is the scheduling server that receives uploading requests from all host users in the video platform and responds to individual uploading requests according to the resource processing status in the whole video platform.

In 102, the scheduling server selects a resource server for processing the uploading request.

By parsing the domain name of the uploading request, the scheduling server can obtain the IP address of the host user, and thereby identifying the area where the host user is located. Meanwhile, the scheduling server monitors in real time load status of all distributed resource servers in the video platform and data transmission performance of the network, so that the scheduling server can select a resource server having better data transmission performance to receive live video uploaded by the host user. In the system made up of distributed resource servers, resource servers are deployed at areas close to users so as to avoid reduction in access quality resulted from long distance access.

In 103, the scheduling server sends the uploading request to the resource server.

After selecting a distributed resource server for processing the uploading request, the scheduling server forwards the request to the selected resource server, or redirects the uploading request to the corresponding resource server so that the resource server can receive the live video uploaded by the host user.

Correspondingly, an embodiment of the present disclosure further provides a method for obtaining live video. As shown in FIG. 2, the method is applied in a resource server in the video platform. The resource server is a distributed resource server which delivers video data using a Content Delivery Network (CDN). The method can include the following specific steps.

In 201, a resource server receives an uploading request for uploading live video by a host user from a scheduling server.

As a corresponding step of the above step 103 in which the scheduling server sends the uploading request, the resource server receives the uploading request in this step. Further, the resource server can receive the uploading request redirected by the scheduling server. Since the resource server transmits video data via the CDN, the resource server in the network serves as an edge server facing users in the CDN. The resource server is deployed in areas close to the host user, data transmission over multiple areas can be avoided when the host user uploads live video, and thus this can prevent data transmission efficiency being influenced by path congestion or failures of relay nodes.

In 202, the resource server receives live video uploaded by the host user according to the uploading request.

The resource server establishes a communication connection with the host user according to the received uploading request, and receives the live video uploaded by the host user. The live video can be uploaded to the resource server in a form of streaming media file.

In 203, the resource server sends the live video to a client on which a viewer requests to view the live video using the CDN.

While the host user uploads the live video, other users can view the live video on line using clients. Similar with the procedure for the host user to upload live video, a viewer user needs to send a viewing request to the video platform using a client, and after the viewer user is authenticated, a resource server offering services to the viewer user obtains live video from the resource server which the host user uploads live video to, and then sends the obtained live video data to the client corresponding to the viewer user. If the resource server offering services to the viewer user and the resource server which the host user uploads live video to are the same one, i.e., the viewer user and the host user are located in the same area, the resource server responsible for the services in the area directly sends the live video to the client corresponding to the viewer user.

As can be seen from the above implementations, in the method for obtaining live video employed by embodiments of the present disclosure, existing resource servers are distributed at areas relatively close to users, and processing and analysis of uploading requests for uploading live video by host users are centralized in the scheduling server, so that the scheduling server can determine a resource server for receiving the live video according to the whole network status of the video platform. The selected resource server is one of the multiple distributed resource servers in a CDN. The selected resource server sends the live video to clients corresponding to viewers who request to view the live video using the CDN. As compared with the existing method in which resource servers are deployed in centralized way, the technical solutions in embodiments of the present disclosure can select a server having better data transmission status to provide service for the uploading of the live video data by the host user. Thus, reduction in service quality of centralized resource servers in case of heavy load can be avoided.

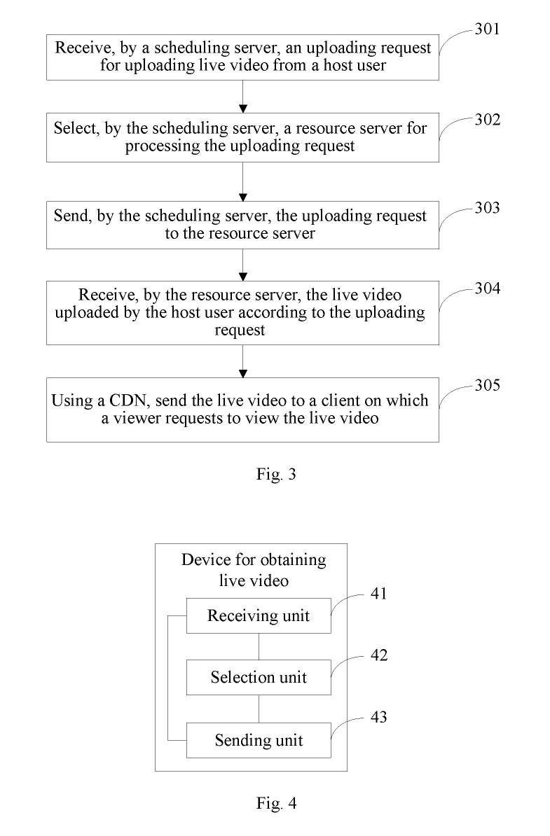

In order to explain the method for obtaining live video proposed by embodiments of the present disclosure, the following descriptions will be made by combining the above two methods. As shown in FIG. 3, the method can include the following specific steps.

In 301, a scheduling server receives an uploading request for uploading live video from a host user.

After receiving the uploading request sent from the host user, the scheduling user needs to parse the request to obtain user information of the host user carried in the request. The user information can include user name and account information of the host user and the like. By analyzing the user information, for example, including a series of examination steps, such as, determining whether the user is a registered user, whether the account of the user is in deficit, and whether the user is in a blacklist because of bad record, the scheduling server can determine whether the user has a permission to upload live video. Parsing of the uploading request can also be performed by searching for the user information records saved in the video platform by the user by way of an IP address corresponding to the user which is obtained by domain name resolution to the request.

After the above examination on the user permission, for the uploading request sent from a user who does not have a permission, the scheduling server notifies the user that he/she does not have a permission to upload live video, or the scheduling server can directly delete the uploading request without sending a response. For the uploading request sent from a user who has a permission, the scheduling server configures a resource server for receiving live video data in response to the uploading request.

In 302, the scheduling server selects a resource server for processing the uploading request.

The main consideration for the scheduling server to select a resource server for processing the uploading request is the current working status of the resource server. Thus, before selecting of a resource server, the scheduling server needs to obtain status information of all current resource servers in the video platform so as to determine which resource servers are available. The status information of each of the resource servers mainly includes the load status information and data transmission speed information of the resource server. The current network status of a resource server and whether the resource server is in a power off state can be determined by the data transmission speed information, and whether a resource server is capable of processing corresponding live video uploading task can be determined by the load status information. Specific methods for obtaining such information in real time can be found in conventional technologies, for example, realtime monitoring on the distributed resource servers can be realized by keepalive packets. However, embodiments of the present disclosure are not limited to the methods for obtaining status information of resource servers as described herein.

As for the obtained status information of all resource servers, the scheduling server generates a resource server list locally. All the resource servers currently in a working state and status information of the resource servers are recorded in the list. The data in the list can be updated according to realtime status changes. For example, data in the list can be updated regularly, or the data in the list can be updated upon receipt of a notification about a new incoming uploading request, and embodiments of the present disclosure do not impose specific limitations on this.

After obtaining the status information of all the resource servers currently in the video platform, the scheduling server processes the uploading request sent from the host user. Specifically, the scheduling server obtains the IP address of the host user by domain name resolution so as to determine the area where the host user is located. Meanwhile, the scheduling server selects from the resource server list some resource servers located in an area which is the same or similar with the area indicated by the IP address of the host user, and then, according to the current status information of the resource servers, the scheduling server identifies from the resource servers a most suitable resource server to which the host user can upload live video using a preset policy. The preset policy can be adjusted or modified by a system administrator according to specific conditions. In embodiments of the present disclosure, the main consideration of the policy gives the priority to the geographic positions of the resource servers and the host user and the data transmission speed of the resource servers, and then takes whether the operator corresponding to the user and the operator corresponding to the resource servers are the same one into consideration. Then, according to the policy, a resource server which is geographically close to the host user and in the same operator network with the host user and has a relatively light load is selected as the resource server for processing the uploading request.

In 303, the scheduling server sends the uploading request to the resource server.

After selecting the resource server for receiving live video, the scheduling server sends the uploading request to the selected resource server. According to the uploading request, the resource server sends information to the host user to notify the host user that the resource server will accept the live video to be uploaded by the host user, and meanwhile the resource server allocates necessary processing resources for processing the live video data to be uploaded.

In 304, the resource server receives the live video uploaded by the host user according to the uploading request.

According to the information sent by the resource server, the host user starts to upload live video on his/her own initiative. Since the resource server and the host user are located in the same or adjacent areas, the live video data uploaded by the host user can arrive at the resource server along a relatively short network path, thereby reducing the possibility of failed nodes in the path. Consequently, continuity in data transmission can be guaranteed, and a relatively high data transmission speed can be arrived at.

In 305, the resource server sends the live video to a client on which a viewer requests to view the live video using a CDN.

The resource server locally stores the received live video data. When another user in the video platform request to view the live video, for example, by tapping a view button, the scheduling server can assign a resource server close to the viewer user and having relatively high transmission speed for the viewer user so as to provide live video data. For the purpose of distinguishing, the resource server (which is assigned by the scheduling server for the viewer user) is defined as a demand server. Whether the demand server has the data resource uploaded by the host user and whether the demand server is the resource server which stores the live video data can be determined. If the demand server stores the live video data, the video data can be directly sent to the viewer user; if the demand server does not store the live video data, the demand server sends an obtaining request for obtaining the live video to a resource server which stores the live video data, and then the resource server sends the live video data to the demand server using the CDN in response to the obtaining request. It should be noted that when the viewer user requests to view the live video, the scheduling server can also determine whether the viewer user has a permission. Meanwhile when assigning the demand server, if the scheduling server determines that the demand server and the resource server which stores the live video data are not the same one, the scheduling server sends the information, especially the IP address, of the resource server which stores the live video data to the demand server, so that the demand server can obtain live video data from the resource server.

Further, an embodiment of the present disclosure provides a device for obtaining live video to implement the above methods. The device can be provided in a scheduling server in a video platform. As shown in FIG. 4, the device can include a receiving unit 41, a selection unit 42, and a sending unit 43.

The receiving unit 41 is configured to receive an uploading request for uploading live video from a host user.

The selection unit 42 is configured to select a resource server for processing the uploading request received by the receiving unit 41 among multiple distributed resource servers.

The sending unit 43 is configured to send the uploading request received by the receiving unit 41 to the resource server selected by the selection unit 42 so that the resource server receives the live video uploaded by the host user.

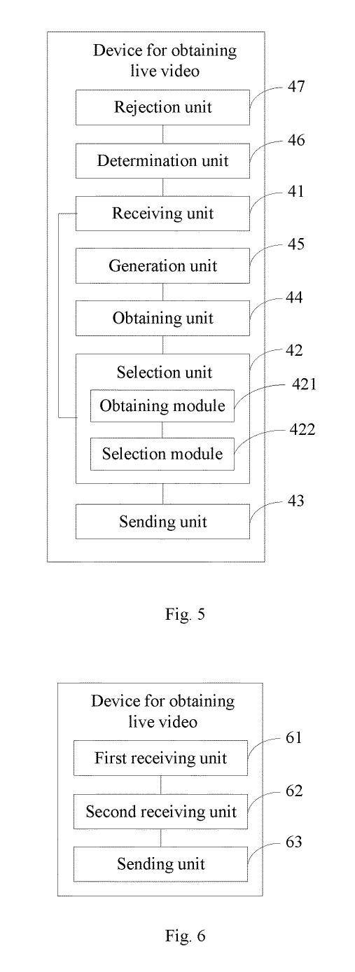

Further, as shown in FIG. 5, the device can further include an obtaining unit 44 and a generation unit 45.

The obtaining unit 44 is configured to, before the selection unit 42 selects the resource server for processing the uploading request, obtain status information of the multiple distributed resource servers, wherein the status information includes at least load status information and data transmission speed information of the resource servers.

The generation unit 45 is configured to, according to the status information obtained by the obtaining unit 44, generate a resource server list in which all distributed resource servers and status information corresponding to the resource servers are recorded.

Further, as shown in FIG. 5, the selection unit 42 includes an obtaining module 421 and a selection module 422.

The obtaining module 421 is configured to obtain user information of the host user according to the uploading request.

The selection module 422 is configured to select a resource server matching the user information obtained by the obtaining module 421 from the resource server list using a preset policy.

As shown in FIG. 5, the device further includes a determination unit 46 and a rejection unit 47.

The determination unit 46 is configured to, after the receiving unit 41 receives the uploading request for uploading the live video from the host user, determine whether the host user has a permission to upload the live video.

The rejection unit 47 is configured to, if the determination unit 41 determines that the host user does not have the permission, reject the uploading request.

Further, an embodiment of the present disclosure provides a device for obtaining live video. As shown in FIG. 6, the device can include a first receiving unit 61, a second receiving unit 62, and a sending unit 63.

The first receiving unit 61 is configured to receive an uploading request for uploading live video by a host user from a scheduling server.

The second receiving unit 62 is configured to, according to the uploading request received by the first receiving unit 61, receive the live video uploaded by the host user.

The sending unit 63 is configured to, using a content delivery network, send the live video received by the second receiving unit 62 to a client on which a viewer requests to view the live video.

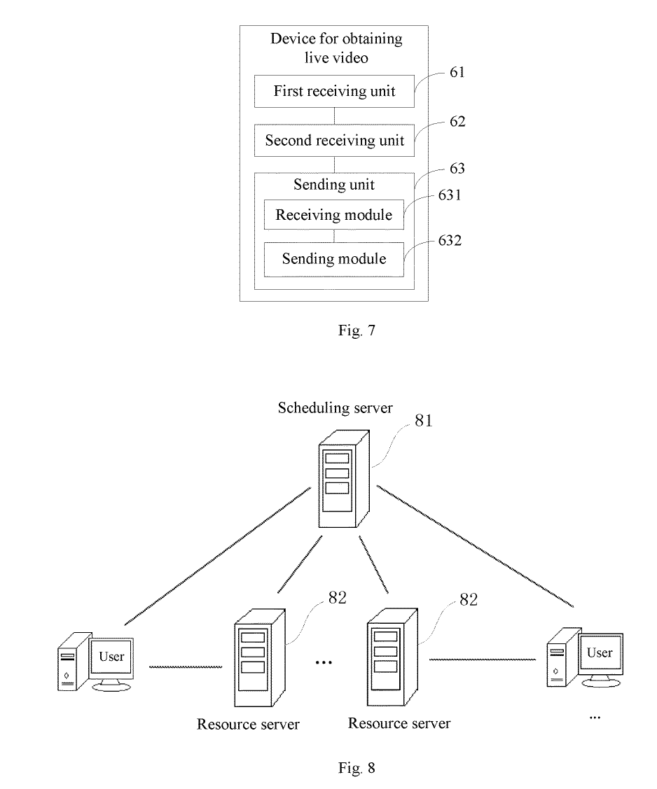

Further, as shown in FIG. 7, the sending unit 63 can include a receiving module 631 and a sending module 632.

The receiving module 631 is configured to receive an obtaining request for obtaining the live video from a demand server which is a distributed resource server that receives from the client the obtaining request for obtaining the live video.

The sending module 632 is configured to send the live video to the demand server according to the obtaining request received by the receiving module 631.

Further, an embodiment of the present disclosure provides a system for obtaining live video. As shown in FIG. 8, the system can include a scheduling server 81 which includes the above device for obtaining live video and a resource server 82 which includes the above device for obtaining live video.

The scheduling server 81 is configured to receive an uploading request for uploading live video from a host user, select the resource server for processing the uploading request, and send the uploading request to the resource server 82.

The resource server 82 is configured to receive the uploading request for uploading live video by the host user from the scheduling server 81, receive the live video uploaded by the host user according to the uploading request, and using a content delivery network, send the live video to a client on which a viewer requests to view the live video.

In view of the above, in the methods, devices, and system for obtaining live video provided by embodiments of the present disclosure, multiple distributed resource servers which are connected via a CDN, and a scheduling server constitute a system for uploading, storing, downloading and viewing of live video. The resource servers are deployed in areas close to users in a distributed way, and processing and analysis of uploading requests for uploading live video sent from host users are centralized in the scheduling server. The scheduling server determines a resource server for receiving the live video according to the whole network status of the video platform. The selected resource server is one of the multiple distributed resource servers in a CDN. The selected resource server sends the live video to clients corresponding to viewers who request to view the live video using the CDN. As compared with the existing method in which resource servers are deployed in a centralized way, the technical solutions in embodiments of the present disclosure can select a server having better data transmission status to provide service for the uploading of the live video data by the host user. Thus, reduction in service quality of centralized resource servers in case of heavy load can be avoided.

It should be noted that the functions of respective units or modules in the above device for obtaining live video according to embodiments of the present disclosure can be realized by hardware processors.

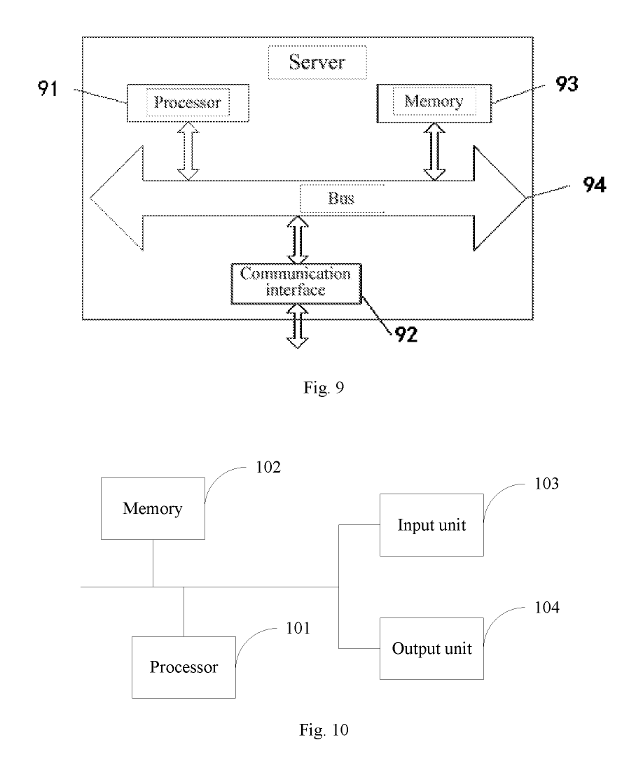

As an example, FIG. 9 is a block diagram showing a device for obtaining live video in accordance with an embodiment of the present disclosure. In the embodiment, the device for obtaining live video is provided in a physical server. The server can include a processor 91, a communication interface 92, a memory 93 and a bus 94. The processor 91, the communication interface 92 and the memory 93 communicate with each other via the bus 94. The communication interface 92 may be used for information transmission between the server and a client. The processor 91 calls logic instructions in the memory 93 to perform the following method: receiving an uploading request for uploading live video from a host user; selecting a resource server for processing the uploading request among multiple distributed resource servers; and sending the uploading request to the selected resource server so that the resource server receives the live video uploaded by the host user.

In addition, the logic instructions in the memory 93 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for obtaining live video mentioned by embodiments of the present disclosure.

FIG. 10 is a block diagram of an electronic device which is configured to perform the methods for obtaining live video according to an embodiment of the present disclosure. As shown in FIG. 10, the device includes: one or more processors 101 and memory 102. A processor 101 is showed in FIG. 10 for an example.

Device which is configured to perform the methods for obtaining live video can also include: input unit 103 and output unit 104.

Processor 101, memory 102, input unit 103 and output unit 104 can be connected by BUS or other methods, and BUS connecting is showed in FIG. 10 for an example.

Memory 102 can be used for storing non-transitory software program, non-transitory computer executable program and modules as a non-transitory computer-readable storage medium, such as corresponding program instructions/modules for the methods for obtaining live video mentioned by embodiments of the present disclosure (such as shown in FIG. 4, receiving unit 41, selection unit 42, sending unit 43). Processor 101 performs kinds of functions and obtaining live video of the electronic device by executing non-transitory software program, instructions and modules which are stored in memory 102, thereby realizes the methods for obtaining live video mentioned by embodiments of the present disclosure.

Memory 102 can include program storage area and data storage area, thereby the operating system and applications required by at least one function can be stored in program storage area and data created by using the device for obtaining live video can be stored in data storage area. Furthermore, memory 102 can include high speed Random-access memory (RAM) or non-volatile memory such as magnetic disk storage device, flash memory device or other non-volatile solid state storage devices. In some embodiments, memory 102 can include long-distance setup memories relative to processor 101, which can communicate with the device for obtaining live video by networks. The examples of said networks are including but not limited to Internet, Intranet, LAN, mobile Internet and their combinations.

Input unit 103 can be used to receive inputted number, character information and key signals causing user configures and function controls of the device for obtaining live video. Output unit 104 can include a display screen or a display device.

The said module or modules are stored in memory 102 and perform the methods for obtaining live video when executed by one or more processors 101.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for obtaining live video, implemented by a scheduling server, comprising:
receiving an uploading request for uploading live video from a host user;
selecting a resource server for processing the uploading request among multiple distributed resource servers; and
sending the uploading request to the resource server so that the resource server receives the live video uploaded by the host user.

2. The method according to claim 1, wherein before selecting of the resource server for processing the uploading request, the method further comprises:
obtaining status information of the multiple distributed resource servers, wherein the status information comprises at least load status information and data transmission speed information of the resource servers; and
generating, according to the status information, a resource server list in which all distributed resource servers and status information corresponding to the resource servers are recorded.

3. The method according to claim 2, wherein the selecting of the resource server for processing the uploading request comprises:
obtaining user information of the host user according to the uploading request; and
selecting a resource server matching the user information from the resource server list using a preset policy.

4. The method according to claim 1, wherein after receiving of the uploading request for uploading the live video from the host user, the method further comprises:
determining whether the host user has a permission to upload the live video; and
if the host user does not have the permission, rejecting the uploading request.

5. An electronic device, comprising:
at least one processor; and
a memory communicably connected with the at least one processor for storing instructions executable by the at least one processor, wherein execution of the instructions by the at least one processor causes the at least one processor to:
receive an uploading request for uploading live video from a host user;
select a resource server for processing the uploading request among multiple distributed resource servers; and
send the uploading request to the resource server so that the resource server receives the live video uploaded by the host user.

6. The electronic device according to claim 5, wherein before selecting of the resource server for processing the uploading request, the instructions are executed to cause the at least one processor to:
obtain status information of the multiple distributed resource servers, wherein the status information comprises at least load status information and data transmission speed information of the resource servers; and
generate, according to the status information, a resource server list in which all distributed resource servers and status information corresponding to the resource servers are recorded.

7. The electronic device according to claim 6, wherein the instructions are executed to cause the at least one processor to:
obtain user information of the host user according to the uploading request; and
select a resource server matching the user information from the resource server list using a preset policy.

8. The electronic device according to claim 5, wherein after receiving of the uploading request for uploading the live video from the host user, the instructions are executed to cause the at least one processor to:
determine whether the host user has a permission to upload the live video; and
if the host user does not have the permission, reject the uploading request.

9. An electronic device, comprising:
at least one processor; and
a memory communicably connected with the at least one processor for storing instructions executable by the at least one processor, wherein execution of the instructions by the at least one processor causes the at least one processor to:
receive an uploading request for uploading live video by a host user from a scheduling server;
receive, according to the uploading request, the live video uploaded by the host user; and
using a content delivery network, send the live video to a client on which a viewer requests to view the live video.

10. The electronic device according to claim 9, wherein the instructions are executed to cause the at least one processor to:
receive an obtaining request for obtaining the live video from a demand server which is a distributed resource server that receives from the client the obtaining request for obtaining the live video; and
send the live video to the demand server according to the obtaining request.
